(19) United States
(12) Patent Application Publication
(10) Pub. No.: US 2004/0226400 A1
(43) Pub. Date: Nov. 18, 2004

(54) Accessories for vehicles and method of manufacturing improved accessories for vehicles

(76) Inventor: Eric Proudfit, Mesa, AZ (US)

Correspondence Address: GREENBERG TRAURIG, P.C., Suite 2500, 77 West Wacker Drive, Chicago, IL, 60601, US

(21) Appl. No.: 10/436,789

(22) Filed: May 13, 2003

(51) Int. Cl. B62D 1/06

(52) U.S. Cl. 74/558

(57) ABSTRACT

An accessory for a vehicle, such as a steering wheel cover, with at least one decorative design appliqué affixed to a covering material by a heat transfer method, such as ultrasonic welding. The accessory may be made by molding at least one design appliqué of a thermoplastic material of at least one first pre-selected color. The mold and thermoplastic material are baked in an oven to set or cure the thermoplastic material, removed from the oven, and pressed onto a covering material for the accessory. With the mold surrounding the design appliqué, it is affixed onto the covering material by a heat transfer method, such as ultrasonic welding, and the mold is removed. Alternatively, the accessory may be provided with at least one design appliqué initially applied to the covering material in a rough, unfinished, generally planar shape, and then shaped and cut to its final form when it is affixed to the covering material by the heat transfer method. Such an at least one design appliqué may be initially applied to the covering material in a plurality of rough, unfinished, generally planar shaped, stacked layers.

### BACKGROUND OF THE INVENTION

1. Field of the Invention

The present invention is directed to accessories for vehicles, such as covers for vehicle steering wheels, and a method of manufacturing accessories for vehicles, such as steering wheel covers, and in particular, to steering wheel covers having low relief, three dimensional decorative designs, and a method for manufacturing accessories for vehicles, such as steering wheel covers, that can readily accommodate a variety of low relief, three dimensional decorative designs.

2. Background Art

Accessories for vehicles, such as window sun visor organizers, glove box organizers, litter bags, CD cases, and covers for vehicle steering wheels serve a variety of functional, and decorative purposes. Steering wheel covers, for example, are used for a variety of reasons, including providing the user with a more secure and/or comfortable grip, to help insulate a user from the temperature of the steering wheel, to absorb the user's perspiration, as well as to provide decoration. A variety of materials are used to make such accessories, including leather, plastics, and fabrics. Decorative designs on accessories for vehicles, such as steering wheel covers, are created in the prior art by using materials having patterns as in Burden, U.S. Pat. No. Des 456,324 issued Apr. 30, 2002, by using different colors of materials, by making the covers of alternating radial bands of different materials, as in Nicozisis, U.S. Pat. No. Des. 190,859 issued Jul. 11, 1961 and Strongwater, U.S. Pat. No. 4,800,776 issued Jan. 31, 1989, by molding portions of the steering wheel cover in different configurations, as in Ku, U.S. Pat. No. Des. 444,748 issued Jul. 10, 2001, Hsu, U.S. Pat. No. Des. 443,237 issued Jun. 5, 2001, Tsuneizumi, U.S. Pat. No. 3,726,152 issued Apr. 10, 1993, by gluing on attachments, and by sewing on attachments.

Accessories for vehicles, such as steering wheel covers, may be provided as part of a vehicle's original equipment, but are more often sold as an accessory that is later installed by the owner or user of the vehicle. Generally the later purchased steering wheel cover accessories for vehicles are one of the following three types:

Lace-Up—Foamed polyurethane or leather steering wheel covers that are laced onto a vehicle steering wheel;

Slip-On—Typically a stretchable fabric material with elastic bands sewn into the outer edges of the cover allowing for easy installation onto a vehicle steering wheel; and

Stretch-On—A steering wheel cover that is constructed of a poly-vinyl-chloride, poly urethane, polyester cloth or leather covering material sewn onto a plastically deformable, relatively ridged, supporting molded ring, such as a rubber ring.

The prior art steering wheel covers with the stretchable rubber rings allow for semi-permanent, non-slip installation onto a vehicle steering wheel, without the need of laces or fasteners to keep the steering wheel covers in place. Some prior art Stretch-On steering wheel covers are made of a simple, single covering material, selected from numerous available colors, patterns and textures, that is sewn onto a rubber ring. Other prior art Stretch-On steering wheel covers are made by sewing molded PVC massage grips or nibs, brand logos, or decorative designs together with a covering material to make a decorative steering wheel cover for the rubber ring. The massage grips or decorative designs of soft poly vinyl chloride (“PVC”) are micro injection oven molded and cured in a steel mold, from which they are removed before being sewn together with cut covering material strips to form a continuous loop of covering material. The continuous loop is then sewn onto the molded rubber ring.

Particularly with respect to such later purchased accessories, there remains a need for accessories having a variety of decorative designs available. Accordingly, it would be desirable to provide accessories, such as steering wheel covers, that can be readily and economically produced with a variety of different, colorful, decorative designs, as well as methods of manufacturing such accessories.

These and other desirable characteristics of the present invention will become apparent in the present specification, including claims, and drawings.

### SUMMARY OF THE INVENTION

The present invention is directed, in part, to accessories for a vehicle, such as steering wheel covers, with at least one decorative design appliqué affixed to a covering material by a heat transfer method, such as ultrasonic welding.

In the present invention the covering material may be polyester, polyurethane, or poly vinyl chloride (“PVC”). The at least one design appliqué may be made from a thermoplastic material, such as poly vinyl chloride (“PVC”), and may have a generally rectangular background. A plurality of colors, which may be sharply defined from each other or blend into each other, may be included in the at least one design appliqué.

In the present invention the steering wheel cover accessories comprise an underlying, stretch-on rubber ring having a generally C-shaped cross-section, with the opening of the “C” oriented towards the center of the ring. The covering material is made of a predetermined number of strips, each being generally rectangular with a length greater than a hand grip of any operator of the vehicle and a width greater than the periphery of a cross-section of the ring. The at least one design appliqué is affixed to at least one of the predetermined number of strips of covering material by a heat transfer method. A continuous loop is formed of the predetermined number of strips of covering material sewn together at their respective ends and attached to the stretch-on rubber ring in a manner so as to generally leave open the generally C-shaped cross-section.

There may be three strips of covering material with each strip being of generally the same length and covering approximately a 120° segment of the steering wheel cover. Two design appliqués may be positioned, for example, respectively at about the ten o'clock and two o'clock positions, on the steering wheel cover. Three design appliqués may be positioned approximately 120° apart around the steering wheel cover.

An accessory for a vehicle in accordance with the present invention may be provided with at least one design appliqué which is initially applied to the covering material in a rough, unfinished, generally planar shape, and is shaped and cut to its final form when it is affixed to the covering material by the heat transfer method. Such an at least one design appliqué may be initially applied to the covering material in a plurality of rough, unfinished, generally planar shaped, stacked layers. The plurality of stacked layers may be of the same generally planar shape, or of different generally planar shapes. Some portions of the upper plurality of layers may be removed by the heat transfer method to expose portions of some of the underlying layers.

The present invention is also directed, at least in part, to a method for manufacturing accessories for a vehicle, such as a steering wheel covers. A thermoplastic material of at least one first pre-selected color is inserted in a mold to form the at least one design appliqué . The mold and thermoplastic material are baked in an oven to set or cure the thermoplastic material, removed from the oven, and placed on a covering material for the accessory. The design appliqué, while it is surrounded by the mold, is then affixed onto the covering material by a heat transfer method, such as ultrasonic welding, which is sometimes referred to as sonic welding, and then the mold is removed. The set or cured at least one design appliqué and mold may be inverted after they are removed from the oven so that they are placed on the covering inverted for the heat transfer step.

In the method of the present invention, a thermoplastic material of at least one second pre-selected color may be inserted or injected into the mold already containing the thermoplastic material of the at least one first pre-selected color before the step of baking to form the at least one design appliqué.

The method of the present invention may also comprise the step of forming the mold for the at least one design appliqué with at least one internal division. A thermoplastic material of at least one second pre-selected color may be inserted or injected into the mold already containing the set or cured thermoplastic material of the at least one first pre-selected color to form the at least one design appliqué, and the mold is re-baked in the oven to set or cure the thermoplastic material of the at least one second pre-selected color.

The methods of the present invention may also include the steps of obtaining a stretch-on ring, cutting the covering material into a predetermined number of generally rectangular strips, each having a pair of opposed ends and a pair of opposed sides, applying the at least one design appliqué to at least one of the strips by the heat transfer method, sewing the strips together along respective ends to form a continuous loop of covering material; and securing the continuous loop to the stretch-on rubber ring to cover a steering wheel.

### BRIEF DESCRIPTION OF THE DRAWINGS

FIG. 1 is a perspective illustration of an accessory steering wheel cover according to the present invention;

FIG. 2 is a cross-sectional view taken generally along line 2-2 of FIG. 1;

FIG. 3 is a fragmentary developmental view of a strip of the covering material shown in FIGS. 1 and 2;

FIG. 4 is a cross-sectional view taken generally along line 4-4 of FIG. 3;

FIG. 5 is a reduced scale, front plan view of another embodiment of a steering wheel cover according to the present invention, with a different design appliqué from that shown in FIGS. 1-4;

FIG. 6 is a fragmentary developmental view of a strip of the covering material shown in FIG. 5;

FIG. 7 is a cross-sectional view taken generally along line 7-7 of FIG. 6;

FIG. 8 is a front plan view of another design appliqué according to the present invention;

FIG. 9 is a flow chart of a method of manufacturing a steering wheel cover accessory according to the present invention;

FIG. 10 is a reduced scale, front plan view of yet another embodiment of a steering wheel cover according to the present invention;

FIG. 11 is a fragmentary top, developmental view of a portion of the steering wheel cover shown in FIG. 10, before the design appliqué is completed;

FIG. 12 is a top perspective, fragmentary top view of a portion of the steering wheel cover shown in FIG. 10, after the design appliqué is completed;

FIG. 13 is an enlarged scale, cross-sectional, fragmentary view of a modification of the embodiment shown in FIGS. 10-12; and

FIG. 14 is an enlarged scale, cross-sectional, fragmentary view of another modification of the embodiment shown in FIGS. 10-12.

### DETAILED DESCRIPTION

While this invention is susceptible of embodiment in many different forms, there are shown in the drawings particular embodiments of the invention, with the understanding that the present disclosure is intended to be considered as an exemplification of the principles of the invention and is not intended to limit the invention to the embodiments illustrated.

For convenience of illustration and description, embodiments of the present invention are shown, and primarily described, in the context of a steering wheel cover after-market accessory for vehicles. However, it will be apparent that the present invention is applicable to numerous other vehicle accessories, including vehicle organization accessories such as window sun visor organizers and glove box organizers, and vehicle storage accessories such as litter bags, CD cases, and other accessories.

FIG. 1 is a perspective illustration of part of a steering wheel cover 20 which may be conveniently applied to a vehicle steering wheel (not shown) by a consumer user. Accessory cover 20 generally comprises an underlying, stretch-on rubber, or other resilient material, ring 22 and a covering material 24, formed of strips 26 into a continuous loop 28. At least one design appliqué 30, that is of a height of less than two millimeters, is affixed to the covering material by a heat transfer method, such as ultrasonic welding.

Covering material 24 may be polyester, polyurethane, or poly vinyl chloride (“PVC”). The at least one design appliqué 30 has a generally rectangular background 32 and a barbed wire design 34. Design appliqué 30 may be made from a thermoplastic material, such as poly vinyl chloride (“PVC”). Design appliqué 30 may include a plurality of colors. Thus, generally rectangular background 32, which as shown in FIG. 3 has curved top and bottom ends, is of one pre-selected color, such as black, while barbed wire design 34 is of a second pre-selected color, such as silver. The colors may be sharply defined from each other. The total height of design appliqué 30, comprising generally rectangular background 32 and superimposed barbed wire design 34, is less than two millimeters.

Underlying, stretch-on rubber ring 22 has a generally C-shaped cross-section 42, with the opening 44 of the “C” oriented towards the center of ring 22. Each strip 26 is generally rectangular with a length greater than a hand grip of any operator of the vehicle and a width greater than the periphery of a cross-section of ring 22, and has a pair of opposed ends 46 and pair of opposed sides 48. Continuous loop 28 is formed of the predetermined number of strips 26 of covering material 24 sewn together at their respective ends 46 and attached to stretch-on rubber ring 22 in a manner so as to generally leave open the generally C-shaped cross-section 42.

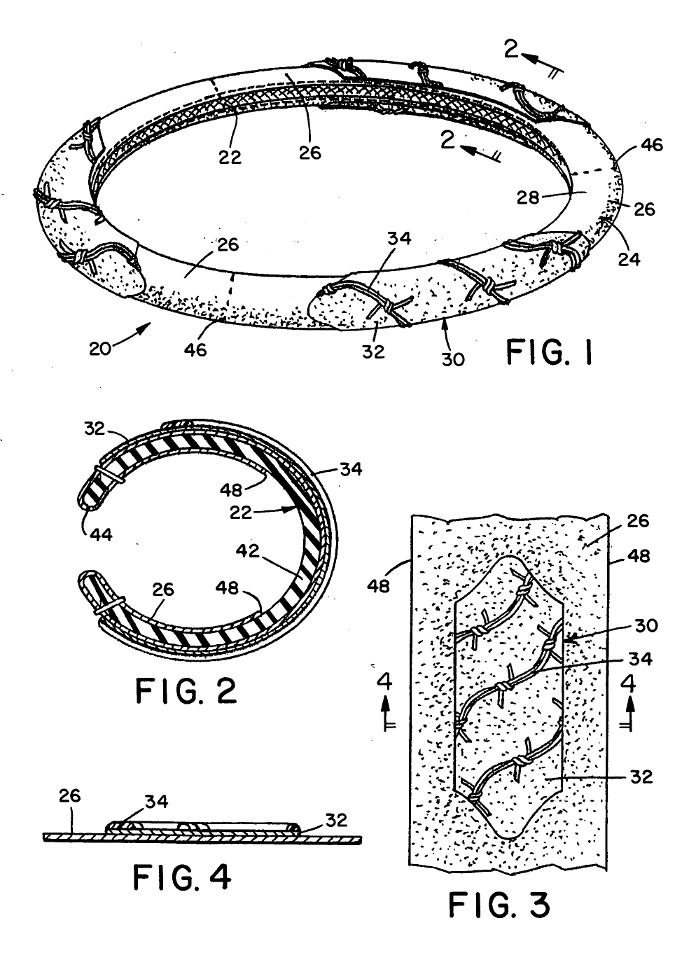

In the embodiment shown in FIGS. 1-4, there are three strips 26 of covering material 24 with each strip 26 being of generally the same length and covering approximately a 120° segment of steering wheel cover 20. A separate design appliqué 30 is affixed to approximately the center of each strip 26 so that the three design appliqués are positioned approximately 120° apart around steering wheel cover 20.

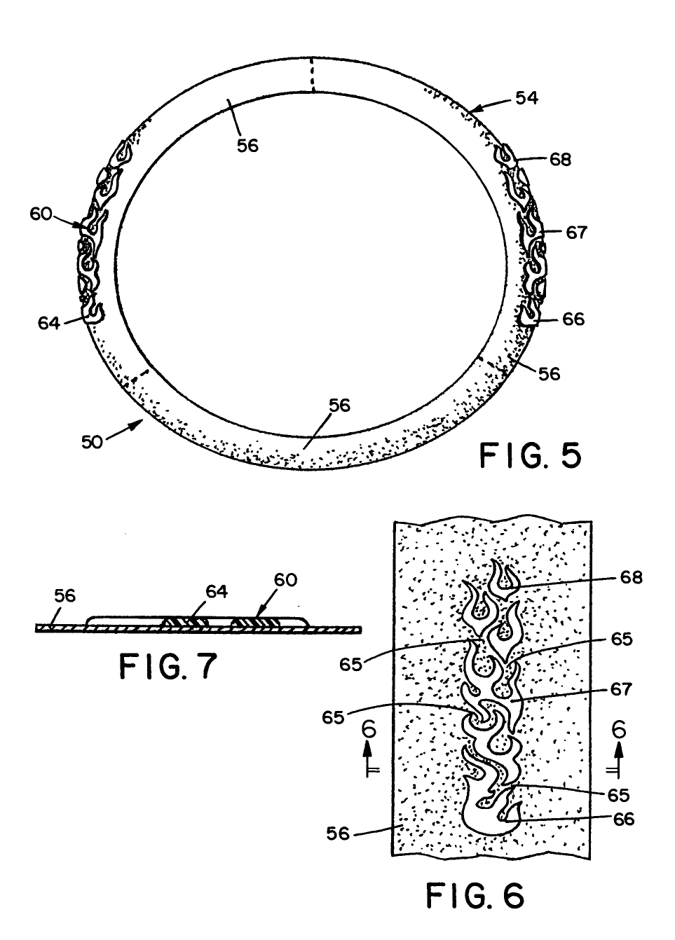

FIGS. 5-7 illustrate another embodiment of the present invention in the context of another steering wheel cover accessory 50 and design appliqué 60. In this embodiment the predetermined number of strips 56 of covering material 54 may conveniently be three or four. Covering material 54 and design appliqué 60 are made of the same type of respective materials as are covering material 24 and design appliqué 30. However, in this embodiment, design appliqué 60 does not include a generally rectangular background. Instead, a molded flame design 64 is ultrasonic welded directly to covering material 54. In the embodiment shown in FIGS. 1-4, barbed wire design 34 could have been similarly sonic welded directly to covering material 24, without generally rectangular background 32.

Portions of flame design 64 are separated from each other by internal divisions in the mold, which are effectively shown on the drawings by separations 65. Flame design 64 may be molded of a number of pre-selected colors of a thermoplastic material. For example, the lower portion of flame design 64 may be made of red thermoplastic material 66, the intermediate portion of orange thermoplastic material 67, and the top portion of yellow thermoplastic material 68, with the colors blending into each other.

As is best shown in FIG. 5, two design appliqués 60 may be positioned, respectively at about the ten o'clock and two o'clock positions on steering wheel cover 50. This may be done by applying a separate design appliqué 60 off-center on each of two of three strips 56, as is illustrated in FIG. 5. Alternatively, a separate design appliqué 60 may be affixed off-center on each of two or four shorter strips (not shown).

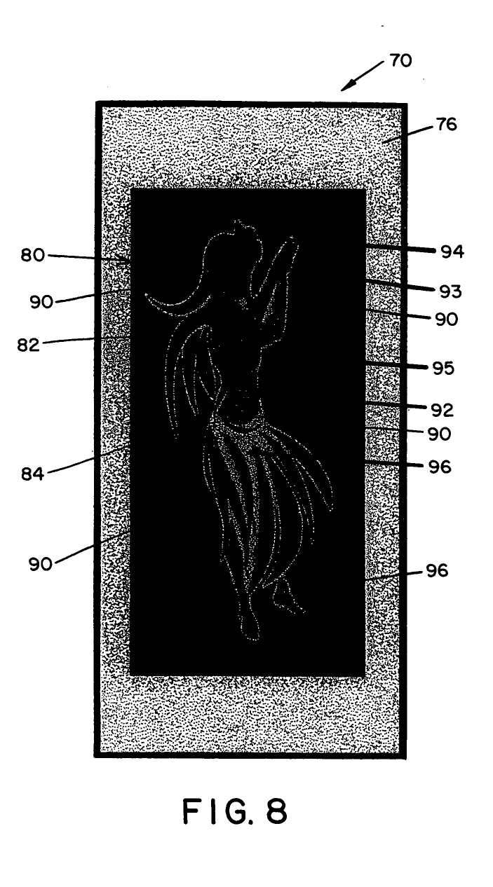

Another embodiment of the present invention is illustrated in FIG. 8, in which an accessory 70 has a more complicated design appliqué 80 in the form of a dancing hula girl 84 on a generally rectangular background 82 affixed to a covering material strip 76. A mold (not separately illustrated) for a design such as dancing hula girl 84, as will be appreciated from the illustration of FIG. 8, is formed with a plurality of internal divisions. Such internal divisions 90 are in effect illustrated in the resulting design of the dancing hula girl 84. The internal divisions facilitate forming a design such as dancing hula girl 84 with a plurality of pre-selected colors sharply defined from each other. For example, the body portions of the dancing hula girl 84 are formed of a flesh color thermoplastic material 92. The dancing hula girl's hair is formed of a black thermoplastic material 93, while the flowers in her hair are formed of a red thermoplastic material 94. The clothing of the dancing hula girl may be formed of a green thermoplastic material 95, together with yellow thermoplastic material portions 96, which may also be used to outline the design.

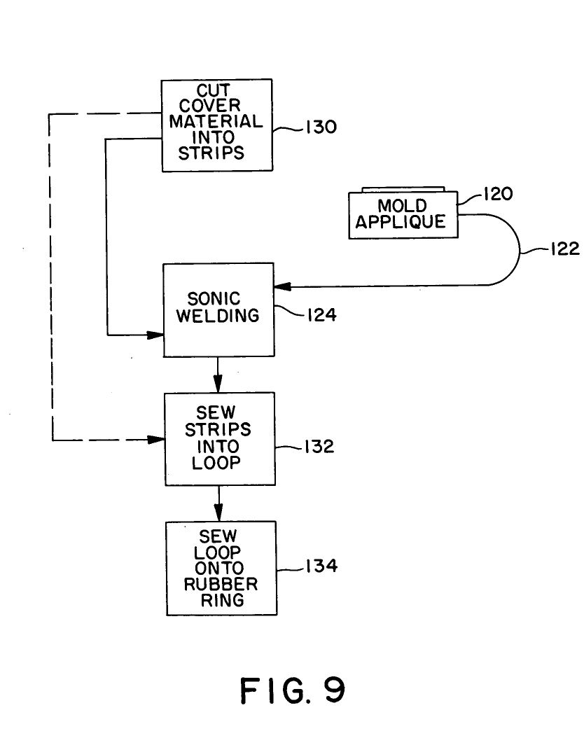

A method for manufacturing accessories for a vehicle, such as steering wheel covers, involves molding the design appliqués and applying them to a covering material by heat transfer, such as by ultrasonic welding. The method of manufacturing the accessories, including the steering wheel covers illustrated in FIGS. 1-8 include the steps schematically illustrated in FIG. 9. In a basic design appliqué, say a design similar to barbed wire design 34, but without the generally rectangular background 32, a thermoplastic material of at least one first pre-selected color is inserted in a mold to form the design appliqué. Preferably, a copper alloy, brass, or aluminum alloy mold is used to evenly conduct electricity required in the later heat transfer, ultrasonic welding, application step.

As illustrated at 120 in the schematic flow chart of FIG. 9, the copper alloy, brass or aluminum alloy mold and thermoplastic material are baked in an oven to set or cure the thermoplastic material. The cured material and the surrounding mold are removed from the oven together, inverted at 122, and pressed upside down onto a covering material for the accessory at 124. The design appliqué, while it is still surrounded by the mold, is then affixed onto the covering material by a heat transfer method, such as ultrasonic welding, again at 124. Then the mold is removed.

To make a more colorful design, such as flame design 64, a thermoplastic material of at least one second pre-selected color is inserted or injected into the mold already containing the thermoplastic material of the at least one first pre-selected color before the step of baking to form the design appliqué. This results -in some blending or bleeding of the colors of one portion of a design such as the flame into the color of another portion, which is aesthetically desirable for the flame design.

However, in order to make a more complicated design, such as dancing hula girl 84, it is desirable to use a copper alloy, brass or aluminum alloy mold with internal divisions to help separate the colors. Thermoplastic material of at least one second pre-selected color is inserted or injected into the mold already containing the set or cured thermoplastic material of the at least one first pre-selected color and the mold is re-baked in the oven to set or cure the thermoplastic material of the at least one second pre-selected color. This may be followed with successive steps for third, fourth, etc. pre-selected colors to form the design appliqué.

In order to make an accessory such as steering wheel cover 20 or 50, additional steps are required. A stretch-on ring 22 is obtained. A covering material 24 is cut into a predetermined number of generally rectangular strips at 130, each strip having a pair of opposed ends and a pair of opposed sides. The at least one design appliqué is affixed to at least one of the strips by the heat transfer method, such as ultrasonic welding, at 124. The strips are then sewn together along respective ends to form a continuous loop of covering material. The continuous loop is then secured, as by sewing, onto a the stretch-on rubber ring at 134 to cover a steering wheel.

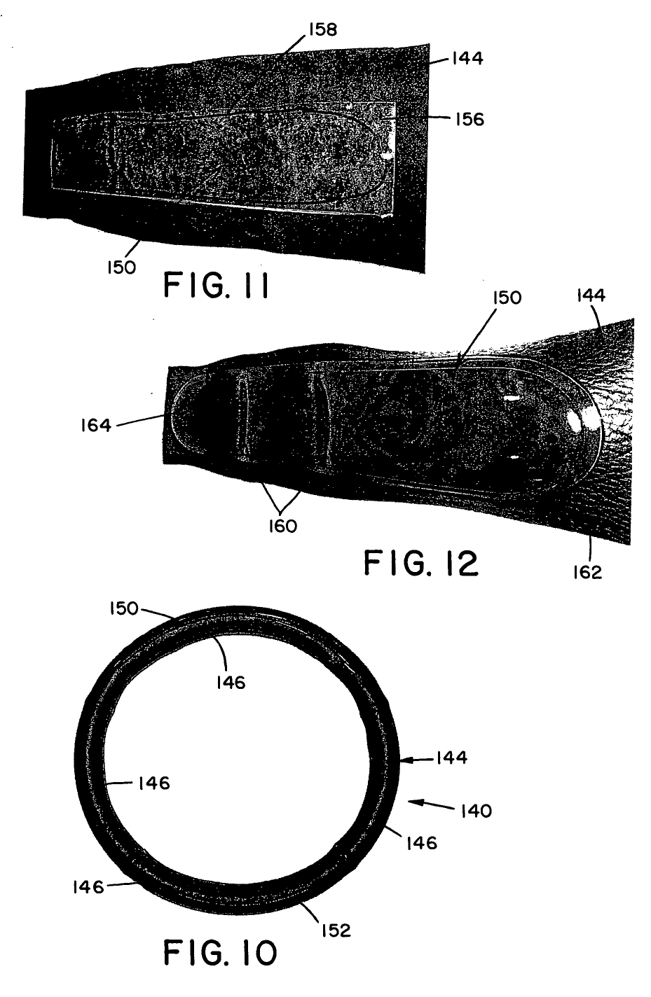

FIG. 10 shows yet another embodiment of a steering wheel cover 140 according to the present invention. As with the other embodiments, steering wheel cover 140 includes an underlying, stretch-on rubber, or other resilient material, ring (not shown) which conveniently fits over a vehicle steering wheel (not shown). Steering wheel cover 140 comprises a covering material 144, formed of four strips 146, into a continuous loop. At least one, low relief, design appliqué 150, that is of a height of less than two millimeters, is affixed to covering material 144 by a heat transfer method, such as ultrasonic welding. In the particular embodiment shown in FIG. 10 there are two design appliqués 150, and 152, which differ in length, but are otherwise similar. It will be understood that further descriptions of design appliqué 150, and its method of manufacture, apply as well to design appliqué 152.

Covering material 144 may be PVC, polyurethane, a polyester, or a polyester containing cloth. As is illustrated in FIG. 11 design appliqué 150 is formed from an initial blank of one layer, or a stack of a multiple number of layers, of a thermo plastic, heat formable material, such PVC, which may initially be applied to covering material 144 in a rough, unfinished, generally rectangular shape 156. While not intended to be a limitation upon the number of layers that may be used with the present invention, up to four layers has so far been found to be preferable.

A tool (not shown) is used to mold, shape, cut and weld the design appliqué to the substrate covering material 144 by a heat transfer process, such as ultrasonic welding. The tool is preferably made of a copper alloy, brass or aluminum alloy to evenly conduct the electricity required during the heat transfer ultrasonic welding. The tool is configured with an outer peripheral shape corresponding to the outline 158 shown in FIG. 11 in order to define the outer periphery of design appliqué 150. In ultrasonically welding design appliqué 150 to cover material 144, the tool also “cuts” the excess material outside the periphery of the desired designed shape, which excess material is then readily removed. As is illustrated in FIG. 12, design appliqué 150 may be formed, during the heat transfer process, to include one or more indentations 160 along with raised end portions 162 and 164.

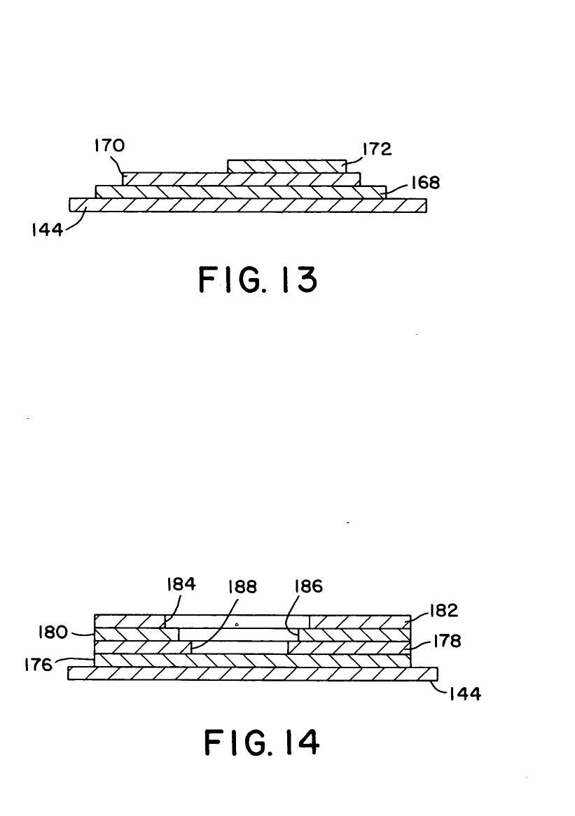

A number of other variations and modifications of this embodiment may be accomplished, particularly using multiple layers. Some of such variations and modifications are illustrated in FIGS. 13 and 14. More particularly, FIG. 13 illustrates how three separate layers 168, 170 and 172 are used to form a design appliqué similar to design appliqué 150. Each of the layers is generally rectangular, although of differing lengths. Thus, as illustrated in FIG. 13 the lowermost layer 168, adjacent covering material 144, is the longest with the next layer 170 being somewhat shorter, and the uppermost layer 172 being the shortest and being offset to one side. In the heat transfer ultrasonic welding process, all three of the stacked layers are welded together, shaped and cut by the tool (not shown). The tool is provided with both peripheral and internal portions, which have sharp edges for cutting, contoured cavities for shaping, and flat areas for melting, welding and shaping.

Accordingly, a design appliqué resulting from the configuration of stacked multiple layers illustrated in FIG. 13 would have higher portion at the one end than at the other. However, not only can the height of the finished design appliqué, or portions of it, be varied by the use of different layers, but the tool itself can also, even with a single layer, by the contoured cavities and flat areas of the tool provide pressure and heat to create high and low impressions on the layer(s) of material. All of the stacked layers may be of the same material, texture and surface design, such as the burlwood appearance of design appliqué 150. Alternatively, the layers may differ in material, texture, and/or surface design, including color.

FIG. 14 illustrates another modification in which four stacked layers of material blanks 176, 178, 180, and 182 are used. Again, each of the layers may initially have a generally rectangular shape, and be of the same, or differing thermo plastic materials, surface texture, and/or surface design, including color. In the modification illustrated in FIG. 14, each of the layers is of generally the same initial rough unfinished rectangular shape and size. However, an opening within the periphery of each of the generally rectangular upper layers is provided, with the uppermost layer 182 having the largest opening 184, the next layer down 180 having a somewhat smaller opening 186 and the next layer down 178 having the smallest opening 188. The bottommost layer 176 is not provided with any opening, although it could be provided with an opening to expose the covering material 144 in still another variation.

Openings 184, 186, and 188 may be initially formed by a separate die cut operation before being stacked in the configuration illustrated in FIG. 14. However, the openings are preferably formed during the single heat transfer processing step by virtue of internal portions of the tool, from the innermost outwardly being shorter by the thickness of the corresponding layer of material, each being provided with sharp bottom edges. If in the modification illustrated in FIG. 14, each of layers 176, 178, 180 and 182 is of a different color such that the internal depression of the resulting completed design appliqué will exhibit step down portions of different colors.

As will be apparent from the foregoing description, and the illustration of FIGS. 1-14, the present invention provides an improved decorative accessory, such as a steering wheel cover, and methods for manufacturing it.

The foregoing description and drawings merely explain and illustrate the invention and the invention is not limited by the description and drawings, except insofar as the appended claims are so limited, as those skilled in the art who have the disclosure before them will be able to make modifications or variations without departing from the scope of the invention.

While particular embodiments of the invention have been shown and described, with some further suggested alternatives, further variations and modifications will occur to those skilled in the art. It is intended in the appended claims to cover all such variations and modifications that come within the true spirit and scope of the present invention.

What is claimed as new and desired to be secured by Letters Patent is:

1. An accessory for a vehicle comprising:
a covering material for the accessory;
at least one decorative design appliqué affixed to the covering material by a heat transfer method.

2. The accessory for a vehicle according to claim 1 in which the at least one design appliqué is affixed to the covering material using a ultrasonic welding heat transfer method.

3. The accessory for a vehicle according to claim 1 in which the covering material is polyester.

4. The accessory for a vehicle according to claim 1 in which the covering material is polyurethane.

5. The accessory for a vehicle according to claim 1 in which the covering material is poly vinyl chloride.

6. The accessory for a vehicle according to claim 1 in which the at least one design appliqué includes a generally rectangular background.

7. The accessory for a vehicle according to claim 1 in which the at least one design appliqué is made from a thermoplastic material.

8. The accessory for a vehicle according to claim 7 in which the at least one design appliqué is made from poly vinyl chloride.

9. The accessory for a vehicle according to claim 1 in which the at least one design appliqué includes a plurality of colors.

10. The accessory for a vehicle according to claim 9 in which the colors of the at least one design appliqué are sharply defined from each other.

11. The accessory for a vehicle according to claim 9 in which the colors of the at least one design appliqué blend into each other.

12. The accessory for a vehicle according to claim 1 in which the at least one design appliqué is initially applied to the covering material in a rough, unfinished, generally planar shape, and is shaped and cut to its final form when it is affixed to the covering material by the heat transfer method.

13. The accessory for a vehicle according to claim 12 in which the at least one design appliqué is initially applied to the covering material in a plurality of rough, unfinished, generally planar shaped, stacked layers.

14. The accessory for a vehicle according to claim 13 in which the plurality of stacked layers are of the same generally planar shape.

15. The accessory for a vehicle according to claim 13 in which the plurality of stacked layers are of different generally planar shapes.

16. The accessory for a vehicle according to claim 13 in which portions of some of the upper plurality of layers are removed by the heat transfer method to expose portions of some of the underlying layers.

17. The accessory for a vehicle according to claim 1 in which the accessory is a cover for a vehicle steering wheel comprising:
an underlying, stretch-on rubber ring having a generally C-shaped cross-section, with the opening of the “C” oriented towards the center of the ring;
the covering material is made of a predetermined number of strips, each being generally rectangular with a length greater than a hand grip of any operator of the vehicle and a width greater than the periphery of a cross-section of the ring;
the at least one design appliqué is affixed to at least one of the predetermined number of strips of covering material by a heat transfer method; and
a continuous loop formed of the predetermined number of strips of covering material sewn together at their respective ends and attached to the stretch-on rubber ring in a manner so as to generally leave open the generally C-shaped cross-section.

18. The cover for a vehicle steering wheel according to claim 17 in which the predetermined number of strips of covering material is three with each strip being of generally the same length and covering approximately a 120° segment of the steering wheel cover.

19. The cover for a vehicle steering wheel according to claim 17 in which there are two design appliqués that are positioned, respectively at about the ten o'clock and two o'clock positions on the steering wheel cover.

20. The cover for a vehicle steering wheel according to claim 17 in which there are three design appliqués positioned approximately 120° apart around the steering wheel cover.

21. A method of manufacturing an accessory for a vehicle comprising:
providing a covering material for the accessory; and
forming at least one design appliqué of a thermoplastic material and affixing the at least one design appliqué onto the covering material by a heat transfer method.

22. The method of claim 21 including:
forming a mold for the at least one design appliqué;
inserting the thermoplastic material of at least one first pre-selected color into the mold to form the at least one design appliqué;
baking the mold and thermoplastic material in an oven to set or cure the thermoplastic material;
removing the at least one design appliqué and mold from the oven;
placing the set or cured at least one design appliqué and mold on the covering material;
affixing the at least one design appliqué, while it is surrounded by the mold, onto the covering material by the heat transfer method; and
removing the mold.

23. The method according to claim 22 in which applying the at least one design appliqué to the covering material by a heat transfer method uses ultrasonic welding.

24. The method according to claim 22 including inverting the set or cured at least one design appliqué and mold after they are removed from the oven so that they are placed on the covering material in an inverted position for affixing by heat transfer.

25. The method according to claim 22 including inserting a thermoplastic material of at least one second pre-selected color into the mold already containing the thermoplastic material of the at least one first pre-selected color before the step of baking to form the at least one design appliqué.

26. The method according to claim 22 including forming the mold for the at least one design appliqué with at least one internal division.

27. The method according to claim 22 including:
inserting a thermoplastic material of at least one second pre-selected color into the mold already containing the set or cured thermoplastic material of the at least one first pre-selected color to form the at least one design appliqué; and
re-baking the mold in an oven to set or cure the thermoplastic material of the at least one second pre-selected color.

28. The method according to claim 21 including:
obtaining a stretch-on ring;
cutting the covering material into a predetermined number of generally rectangular strips, each having a pair of opposed ends and a pair of opposed sides;
applying at least one design appliqué to at least one of the strips by the heat transfer method;
sewing the strips together along respective ends to form a continuous loop of covering material; and
securing the continuous loop to the stretch-on rubber ring to cover a steering wheel.

29. The method according to claim 28 in which cutting a covering material results in three strips of covering material, each strip being of generally the same length in order to form approximately a 120° segment of the steering wheel cover.

30. The method according to claim 28 including:
positioning the at least one design appliqué on one of the number of strips;
positioning another at least one design appliqué on another of the number of strips; and
sewing the predetermined number of strips together such that the design appliqués may be at about the ten o'clock and two o'clock positions on the steering wheel.

31. The method according to claim 21 further comprising:
applying a rough, unfinished, generally planar shape to the covering material; and
shaping and cutting the design appliqué to its final form when it is affixed onto the covering material by heat transfer.

32. The method according to claim 31 further comprising:
applying a stack of the rough, unfinished, generally planar shapes to the covering material; and
shaping and cutting the stack to the final form of the design appliqué when it is affixed onto the covering material by heat transfer.
